(19) United States
(12) Patent Application Publication
(10) Pub. No.: US 2013/0264429 A1
(43) Pub. Date: Oct. 10, 2013

(54) CONVERTIBLE AIRPLANE

(71) Applicants: Pavel MIODUSHEVSKY, (US); SKEM@ S.R.L., Brindisi (BR) (IT)

(72) Inventor: Pavel MIODUSHEVSKY, BRINDISI (BR) (IT)

(21) Appl. No.: 13/743,763

(22) Filed: Jan. 17, 2013

(30) Foreign Application Priority Data
Jan. 17, 2012 (IT) RM2012A000014

(51) Int. Cl. B64C 29/00

(52) U.S. Cl. CPC B64C 29/0008
USPC 244/7 A

(57) ABSTRACT

A convertible airplane is described. The convertible airplane has a fuselage, a trapezoidal wing, two counter rotating front rotors, and an aft rotor.

### CROSS REFERENCE TO RELATED APPLICATIONS

The present application claims priority to Italian Application no. RM2012A000014 filed on Jan. 17, 2012 and incorporated herein by reference in its entirety.

### DESCRIPTION

The present invention is related to the field of general aviation and could have applications for the aircraft that has a pilot on board as well as for highly automated Unmanned Air Vehicle (UAV).

In aviation it is well known convertible aircraft V22 Osprey that was developed by the companies Bell Helicopter Textron and Boeing. Bell Helicopter Textron also have developed unmanned air vehicle TR918 Eagle Eye that has aeromechanical scheme that is like scheme of V22 Osprey (see Grande Enciclopedia Ilustrata “Aerei ed Elicotteri di tutto mondo” DeAgostini).

Disadvantages of the convertible aircraft of the V22 Osprey type are following:
a) Two heavy engines are installed at the ends of the wing consoles, wing span is equal to the distance between axes of the engines; for this reason it is necessary to provide high stiffness of the wing that is increasing of the structural weight significantly.
b) In the case of the aeromechanical scheme type of Osprey the wing span should be very limited. The wing span cannot be expanded because the problem of the aero-elastic vibration will became so severe that it cannot be resolved.
c) An Osprey scheme aircraft have not possibility to make a landing like an aircraft of the normal scheme.
d) In the vertical flight wing area is perpendicular to flow from the rotors, disturbing this flow significantly.
e) The system of Osprey type have a very limited possibility to compensate the variation of the center of gravity position. Control of the pitch, roll and linear movements in longitudinal and lateral directions during vertical flight may be provided only by the regulation of the thrust of the rotors and by the control of angles of the rotors axes rotations. The system has no other control means. This fact is limiting significantly the precision of the control of aircraft position in the vertical or quasi vertical flight.

Other well-known type of the convertible aircraft is Canadair CL-84 (http://en.wikipedia.org/wiki/Canadair_CL-84). Disadvantages of the convertible aircraft of the Canadair CL-84 type are following:
1. The wing, that is rotating in the vertical-longitudinal plane together with two rotors, cannot produce the useful lift in the transition flight, when two rotors have quasi vertical position.
2. The aft rotor, that in vertical flight provides equilibrating force, is not useful in horizontal flight.
3. Lateral displacement in vertical flight requires to execute a necessary roll by the certain angle.

In the International Publication Number WO 2007/110833 A1 the system of the convertible aircraft with two co-axial counter rotating rotors was described. Disadvantages of the convertible aircraft of this type are following:
1. The center of the rotor should be very close to center of aircraft gravity in horizontal plane.
2. This type of the system can be realized only for the light aircraft because its rotor should have too large diameter in order to provide a lift of the heavy aircraft. In this case the helicopter scheme is preferable.

The goal of the present invention is to solve the problems of the convertible aircraft and to provide aeromechanical scheme of the convertible aircraft that will be free from the mentioned above disadvantages.

This problem will be resolved by the apparatus that is corresponding to claims 1. The present invention provides important advantages. One of the principle advantages is that present invention provides increase of the efficiency and safety of the convertible aircraft.

The present invention provides that position of the aircraft center of gravity may have significant variations and this variations will not cause the problem of stability in vertical flight or during transition from the vertical flight to horizontal flight and vice versa.

Other advantages, characteristics and modes of the usage of the present invention will be evident from the following detailed description of some forms of realization of the present invention, that are presented as examples and forms of realization of the present invention are not limited by these examples.

In description will used reference to the figures of the attached drawings, wherein:

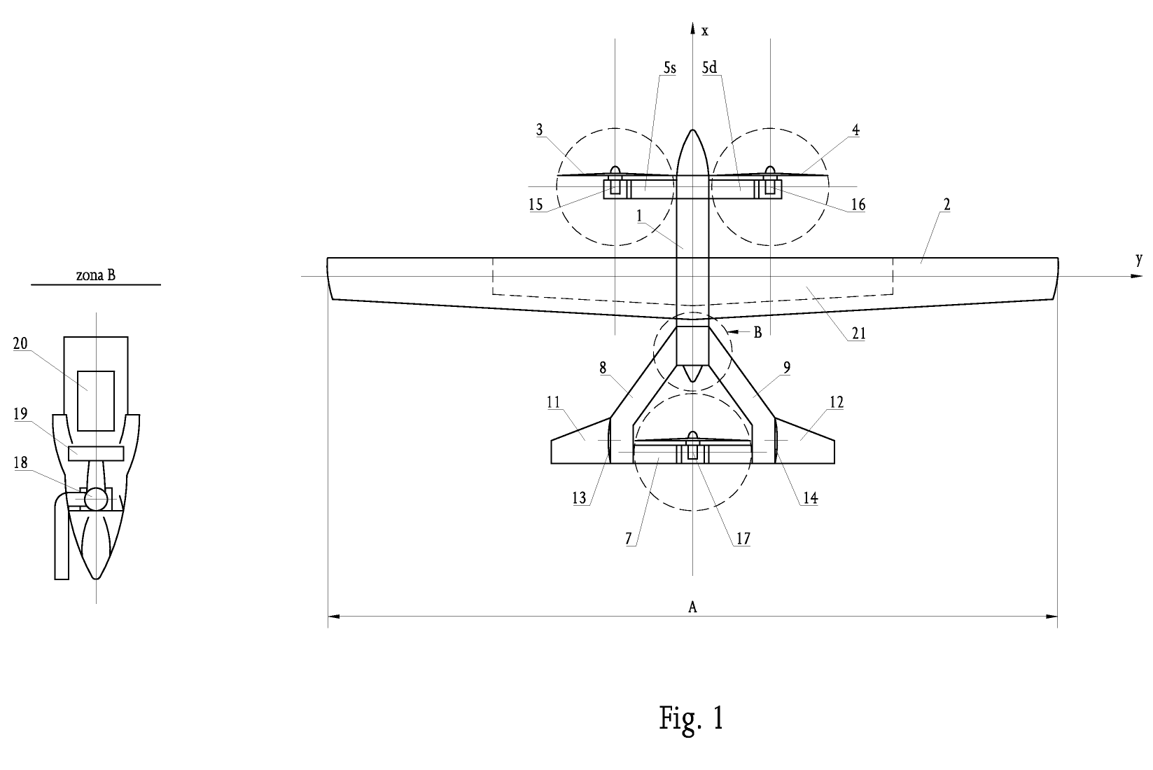

FIG. 1 presents the view in plane of the first form of realization of the convertible aircraft with three motors.

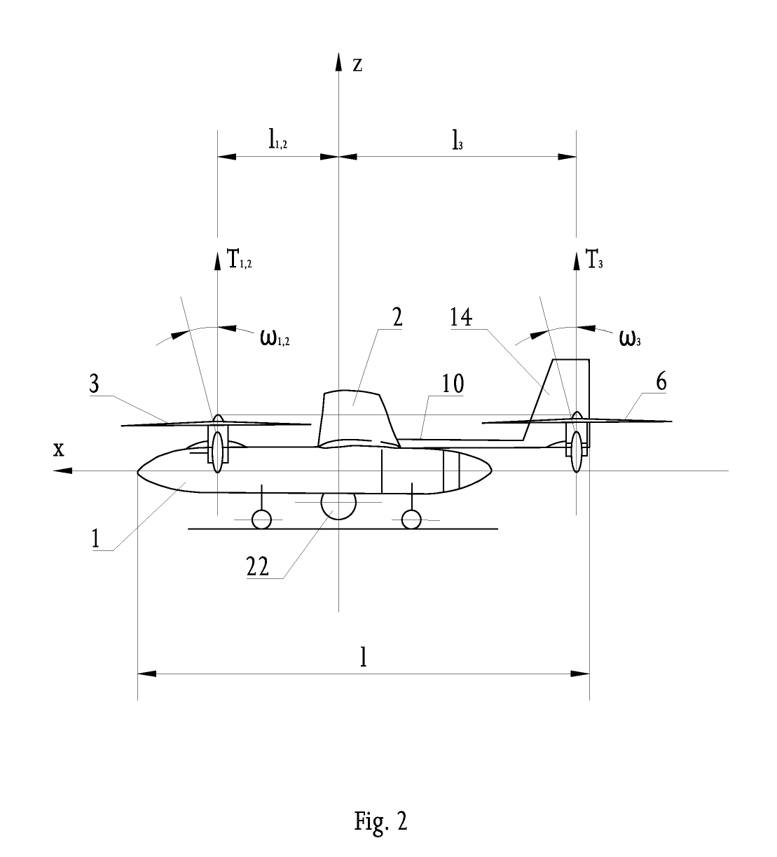

FIG. 2 presents the side view of the first form of realization of the convertible aircraft with three motors.

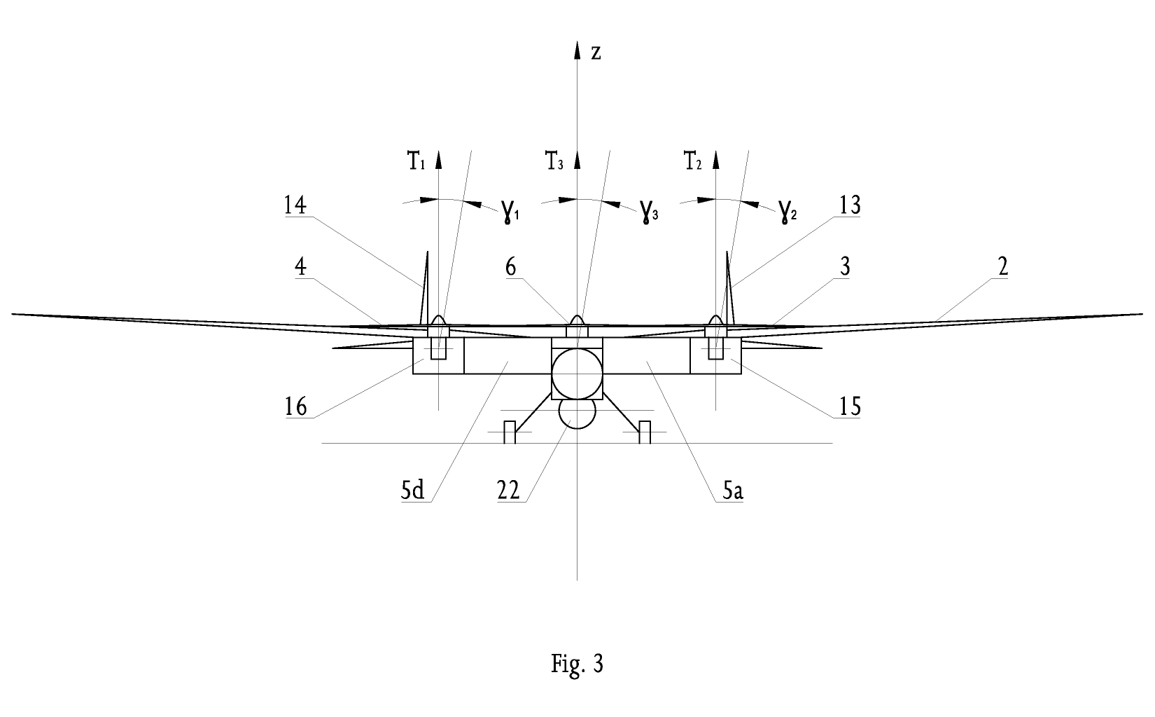

FIG. 3 presents the front view of the first form of realization of the convertible aircraft with three motors.

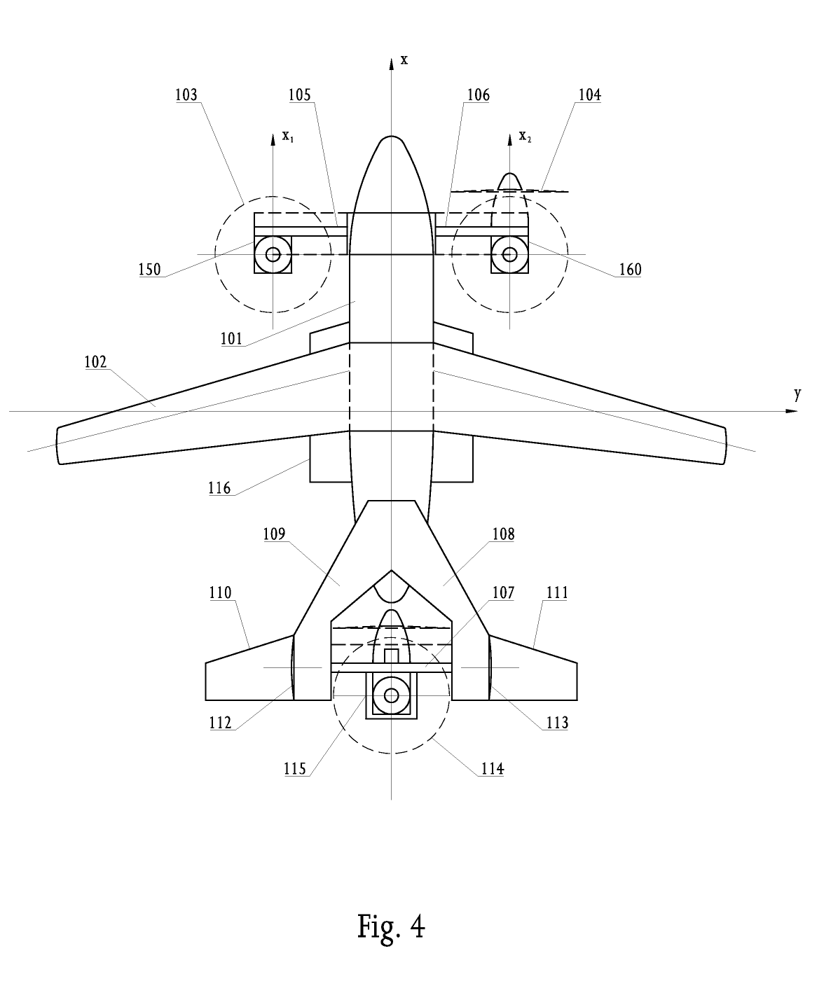

FIG. 4 presents the view in plane of the second form of realization of the convertible aircraft with three motors.

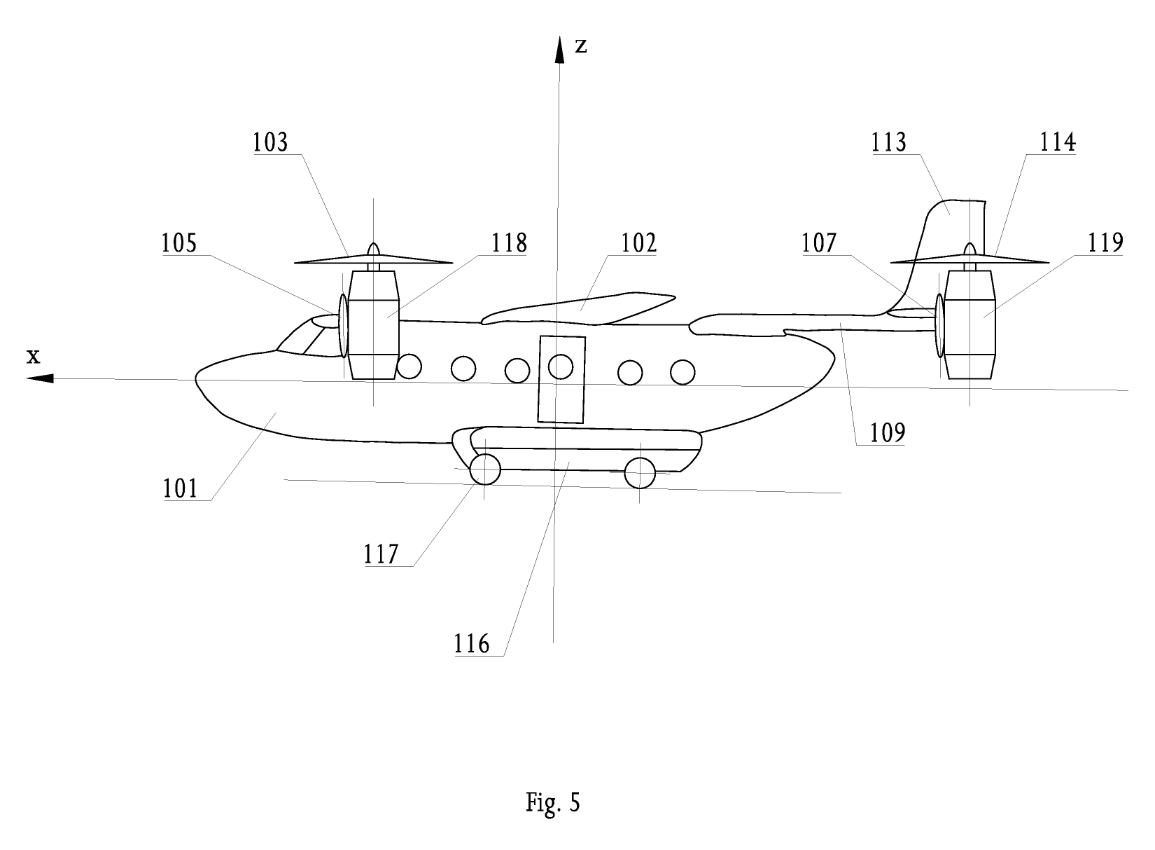

FIG. 5 presents the side view of the second form of realization of the convertible aircraft with three motors.

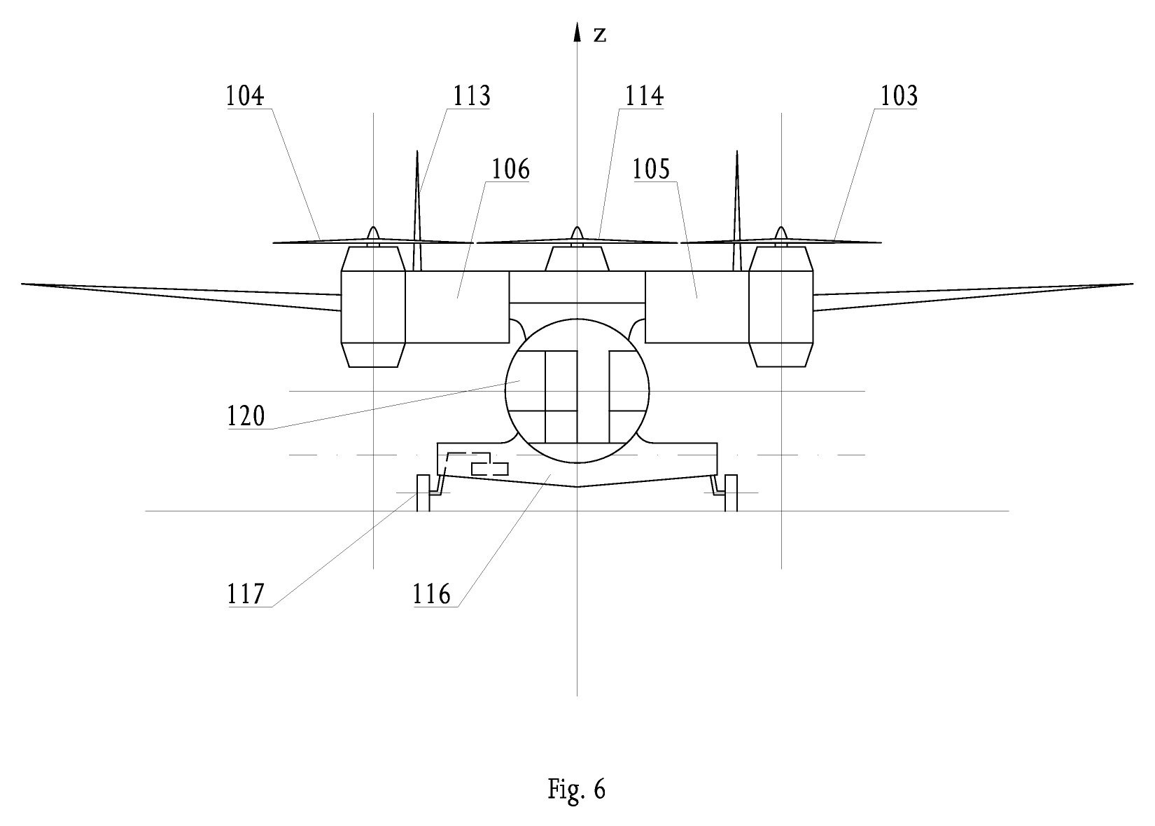

FIG. 6 presents the front view of the second form of realization of the convertible aircraft with three motors.

With reference on the FIGS. 1, 2, 3 we will consider the first form of realization of the convertible aircraft with three motors which is mainly consisting of:
the fuselage 1, trapezoidal wing 2, two front counter rotating rotors 3, 4 and one aft rotor 6. Front rotors are installed on the ends of the two rotating beams 5d and 5s. These beams 5d and 5s are connected between them by the common axis that is perpendicular to the longitudinal axis of fuselage 1. Servomechanism (that is installed inside the fuselage) provides rotation of the beams 5d e 5s on the angle ω_{1,2}, inclining by this action thrust vectors of the front rotors in vertical-longitudinal plane. Two motors of the front rotors are connected with beams 5d and 5s by the two structural boxes of the hinges 15, 16. The axes of the hinges 15,16 are perpendicular to the common axis of the beams 5d and 5s. Two front rotors can rotate around the axes of the hinges 15, 16 with help of the servomechanisms, inclining by this action thrust vectors of the front rotors on the angles γ₁ and γ₂ in planes that are including the axis of front rotating beams 5d, 5s and axis of the hinge 15 for the angle γ₂ and axis of the hinge 16 for the angle γ₁. The aft rotor 6 with his motor is installed by the structural box of the hinge 17 in the center of the aft rotating beam 7. Axis of this beam is connected through two bearings with two symmetric branches 8, 9 of the tail unit structure 10. The beam 7 can rotate with help of the servomechanisms that are installed inside the structures of the branches 8, 9 of tail unit, inclining of the thrust vector of the aft rotor 7 on the angle ω₃ in the vertical-longitudinal plane. The axis of the hinge 17 is perpendicular to the axis of the beam 7. The structural box of the hinge 17 can rotate ,inclining thrust vector of the aft rotor on the angle ω₃ in plane that is including the axis of the rotating beam 7 and is perpendicular to the axis of the hinge 17 (in vertical flight this plane is vertical-lateral plane, see FIG. 3). Two rotating stabilizers 11, 12 and two rotating rudders 13, 14 are installed (using their axes) on the symmetric branches 8, 9 of tail unit structure 10.

In first form of realization of the convertible aircraft by the present invention in the aft part of the fuselage (see FIG. 1) combustion engine 18 with electric generator 19 and power management unit 20 is installed. Engine 18 with electric generator 19 produces electric power that is necessary and sufficient for the propulsion in horizontal flight and electric batteries recharge.

Let us consider as an example of the convertible aircraft in the first form of realization one UAV (unmanned air vehicle), which has following characteristics:
Aircraft weight at vertical take-off . . . 26 kg
Flight endurance . . . 12-24 hours
Cruise velocity . . . 72 km/h
Wing span . . . 3.6 m
Wing area . . . 1.04 m²
Length of the fuselage . . . 1.6 m
Payload . . . video cameras EO/IR/SWIR
Electric motors . . . 3×Himax HC6332-230
Propellers . . . 3×19″diameter
Maximum total thrust . . . 3Tm=36.9 kgf
Hybrid-electric power unit:

reciprocating engine ASP 180 AR

electric generator Sullivan S675-500

electric batteries Li-Po 12S, weight 4 kg

power consumption at cruise . . . 620 W

With reference on the FIG. 1, 2, 3 let us consider control of the convertible aircraft in first form of realization.

During the hovering in the ideal conditions thrust of the three rotors should be the same:

T₁=T₂=T₃=T; T=1/3 G,

where G is a weight of aircraft.

The distance from the aircraft center of gravity to the axis of the front rotating beams l₁₂ and to the aft rotating beam l₃ should be chosen according to the following relation:

l₃=2/l₁₂.

In ideal conditions thrust vectors angles of inclinations should be equal to zero:

ω_{1,2}=ω₃=0; γ₁=γ₂=γ₃=0.

Let us consider disturbing forces and moments and control actions that are necessary for compensation of the disturb and for the equilibrium of aircraft:

$${X}_{d} = \frac{G}{g} \frac{{d}^{2} x}{d {t}^{2}} + 3 T {ω}_{r}$$

$${Y}_{d} = \frac{G}{g} \frac{{d}^{2} y}{d {t}^{2}} + 2 T {γ}_{r 1 , 2} + T {γ}_{r 3}$$

$${Z}_{d} = \frac{G}{g} \frac{{d}^{2} z}{d {t}^{2}} + δ {T}_{1} + δ {T}_{2} + δ {T}_{3}$$

$${M}_{dx} = {I}_{x} \frac{{d}^{2} φ}{d {t}^{2}} + ( δ {T}_{1} - δ {T}_{2} ) a$$

$${M}_{dy} = {I}_{y} \frac{{d}^{2} υ}{d {t}^{2}} + ( σ {T}_{1} + δ {T}_{2} ) {l}_{12} - δ {T}_{3} {l}_{3}$$

$${M}_{dz} = {I}_{z} \frac{{d}^{2} β}{d {t}^{2}} + ( 2 T {γ}_{r 1 , 2} ) {l}_{12} - ( T {γ}_{r 3} ) {l}_{3}$$

X_{d},Y_{d},Z_{d} are the disturbing forces in directions of the axes x, y, z.

M_{dx},M_{dy},M_{dz} are the disturbing moments around the axes x, y, z.

Iₓ,I_{y},I_{z} are the inertia moments of the aircraft around the axes x, y, z.

ωᵣ,γ_{r1,2},γᵣ₃ are the control actions by inclination of the thrust vectors on the indicated angles.

δT₁,δT₂,δT₃ are the control actions by the variation of the thrust of the three rotors .

Thrust variation could be done using the mechanism of the propeller variable pitch for each rotor because RPM control is more slow.

From these equations follows that disturbing force in direction x can be compensated by inclination of the rotating beams (front and aft) on the angle

$${ω}_{r} = \frac{{X}_{d}}{3 T} .$$

When force X_{d} is absent then inclination of the rotating beams (front and aft) on the angle ω will produce acceleration and movement in direction x.

The lateral disturbing force and disturbing moment around the axis z could be compensated by the inclination of front rotors thrust vectors on the angle γ_{r1,2} and inclination of the aft rotor thrust vector on the angle γᵣ₃:

$${γ}_{r 1 , 2} = \frac{1}{3} ( \frac{{Y}_{d}}{T} + \frac{{M}_{dz}}{2 {Tl}_{12}} )$$

$${γ}_{r 3} = \frac{1}{3} ( \frac{{Y}_{d}}{T} - \frac{{M}_{dz}}{{Tl}_{12}} )$$

When the force Y_{d} and moment M_{dz} are absent inclination of the thrust vectors on the angle γ_{1,2}=γ₃ will produce acceleration and movement in direction y, but inclination of the thrust vectors on the angles γ_{1,2}=−γ₃ will produce acceleration and angular movement (rotation of the aircraft) around the axis z.

Vertical disturbing force and disturbing moments, acting around the axes x and y could be compensated by the variations of the three rotors thrusts:

$$δ {T}_{1} = \frac{1}{3} {Z}_{d} + \frac{{M}_{dz}}{2 a} + \frac{{M}_{dy}}{6 {l}_{12}}$$

$$δ {T}_{2} = \frac{1}{3} {Z}_{d} - \frac{{M}_{dx}}{2 a} + \frac{{M}_{dy}}{6 {l}_{12}}$$

$$δ {T}_{3} = \frac{1}{3} {Z}_{d} - \frac{{M}_{dy}}{3 {l}_{12}}$$

When the force Z_{d} and moments M_{dx},M_{dy} are absent:

a) δT₁=δT₂=δT₃,—produce acceleration and movement in direction z.

b) δT₃=0; δT₁=−δT₂,—produce rotation around the axis x.

c) δT₁=δT₂=−δT₃,—produce rotation around the axis y.

It is possible to make a conclusion that convertible aircraft according to the present invention in the vertical flight can be controlled in 6 degree of freedom by the 6 control channels: including three thrusts (for three motors), angle ω of rotation of the beams 5d, 5s, 7 (the same angle for the front beams 5d,5s and aft beam 7), angle of inclination of the aft rotor thrust vector in vertical-lateral plane γ₃, angle of inclination of the front rotors thrust vectors in vertical-lateral plane γ₁=γ₂=γ_{1,2}.

Let us consider the transition from the vertical flight to the horizontal flight. Let us assume that during the vertical flight an aircraft already reach the altitude that is greater than 15 m (altitude of the standard obstacle). Let us assume also that aircraft weight G at the vertical take-off is not greater of the 70% of the maximum total thrust of the three rotors (3Tm). For the angle ω=30° vertical component of the thrust is equal to 0.866 (3Tt). This component should be equal to G. So:

$$\frac{3 Tt}{G} = 1.155 ,$$

where 3Tt is total thrust in the transition phase. Horizontal component of the thrust produces sufficiently high acceleration of the aircraft. In the initial moment this acceleration is equal to

$$5.66 \frac{m}{{sec}^{2}} .$$

During the 4 seconds convertible aircraft (that is UAV in the first form of realization) could have velocity 72 km/h, that is sufficient for horizontal flight. After this moment angle ω can be increased up to 90°, and in the same time the total thrust of the three rotors should be decreased to the value, that is corresponding to the horizontal cruise flight.

Transition from the horizontal flight to the vertical flight requires to rotate the beams 5d, 5s, 7 at the angle ω=0, simultaneously increasing the total thrust up to 3T=G. In order to decrease the distance of transition it is possible to use negative angles of ω, increasing of the total thrust for the aircraft equilibrium in vertical plane. The time, that is necessary for the vertical take-off and transition in the horizontal flight of the convertible UAV is less than 15 seconds. The same time is necessary for the transition from the horizontal flight to the vertical flight and landing of the convertible UAV. Maximum duration of the hovering for the convertible UAV is 12 minutes, using the electric batteries with subsequent recharge.

Convertible aircraft according to the present invention can make take-off like the normal scheme aircraft but in this case convertible aircraft can have more short distance of the take-off, inclining total thrust vector on the optimal angle ω, that is providing minimum length of the take-off distance.

Optimum value of ω can be calculated by the following formulae:

$$ω = arc cos ( \frac{G}{3 T} \pm \sqrt{{( \frac{G}{3 T} )}^{2} - 1} )$$

This formulae have been derived from the integration of the equations of the aircraft movement, minimizing the function of the landing distance.

Convertible UAV according to the present invention can make short distance take-off, using angle ω=30°, and can have the weight 25% greater than normal scheme aircraft and the take-off distance of the convertible aircraft with this greater weight will be 2.6 times shorter that for the normal scheme aircraft.

With reference on the FIGS. 4, 5, 6 let us consider the second form of realization of the convertible aircraft with three motors, that is mainly consisting of:
Fuselage 101, trapezoidal wing 102, two front counter rotating rotors 103, 104 and aft rotor 114. The front rotors are installed on the fuselage before the wing at the ends of the two rotating front beams 105 and 106. These beams 105, 106 are connected between them by the common axis that is perpendicular to the axis of fuselage 101. Servomechanism, that is installed inside the fuselage provides rotation of the beams 105 and 106 on the angle ω_{1,2}, inclining thrust vectors of two front rotors in vertical-longitudinal plane. Two front rotors are connected with beams 105, 106 by the structural boxes of the hinges 150, 160. The axes of the hinges 150, 160 (x₁,x₂) are perpendicular to the common axis of the beams 105, 106. Two front rotors with help of the servomechanisms can rotate around the axes of the hinges 150, 160, inclining thrust vectors on the angles γ₁ and γ₂ in planes that are including axis of front rotating beams and axes of the hinges 150 (for γ₂) and 160 (for γ₁). Aft rotor 114 with its motor 119 is installed in structural box of the hinge 115 that is located in center of the aft rotating beam 107. Axis of this beam is connected through the two end bearings with two symmetric branches 108, 109 of tail unit structure. Inside the structure of the branches 108, 109 the servomechanisms are installed, that provides rotation of the beam 107, inclining the aft rotor 114 thrust vector on the angle ω₃ in vertical-longitudinal plane. Axis of the hinge 115 is perpendicular to axis of the beam 107. Structural box of the hinge 115 is rotating by its the servomechanism, inclining the aft rotor 114 thrust vector on the angle γ₃ in the plane, that is including axis of the aft rotating beam and axis of the hinge 115 (that is vertical-lateral plane during vertical flight). Two rotating stabilizers 110, 111 and two rotating rudders 112, 113 are connected by their axes with two symmetric branches 108, 109 of the tail unit structure. In this second form of realization of the present invention the convertible aircraft is amphibian aircraft (FIG. 4, 5, 6), which is including the component 116 of the fuselage structure. This component 116 has volume that is sufficient for the support of the aircraft weight in water. Four landing gears 117 are retractable. In flight landing gears 117 are retracted in their cavities inside the structure 116. The fuselage 101 has the pilot cabin and compartment 120, that can be used as passenger cabin or cargo compartment or flying ambulance compartment.

In this second form of realization of the present invention convertible aircraft has following characteristics:

Weight at vertical take-off . . . 6500 kg

Number of the pilots and passengers . . . 2+16

Turbo-prop engines . . . 3×PW123B

Maximum total thrust at vertical take-off . . . 7640 kg

Cruise velocity . . . 720 km/h

Cruise altitude . . .8-9 km

Range . . . 3000 km

Wing span . . . 16 m

Fuselage length . . . 11.5 m

Fuselage cabin diameter . . . 2 m

Propeller diameter . . . 2.8 m

Thrust vectors control . . . in longitudinal and lateral planes

It is important to note that amphibian convertible aircraft, having the vertical take-off and landing capability, does not need the fuselage structure form similar to flying boat, that has traditional amphibian aircraft. The loads on the fuselage during the vertical take-off from the water and landing in the water may be significantly less than the loads on the well-known flying boats.

### CONCLUSION

Convertible aircraft according to the present invention provides significant advantages in the first and in the second forms of realization. Three rotors with controllable thrust vectors provides stability and safety of the aircraft in vertical flight and in the phase of transition from the vertical to horizontal flight. High efficiency of the control of the convertible aircraft according to the present invention in the presence of the disturbing forces and moments has been demonstrated. Convertible aircraft according to the present invention may have large variations of the center of gravity position. An aircraft has fixed wing, that provides efficient functioning in the transition phase, wing is free from any mechanization devices. Aerodynamic interference between the wing and rotors in the transition phase is not significant. Convertible aircraft according to the present invention can be made in a new form of amphibian aircraft, that can make take-off and landing in any non-prepared place.

1. A convertible aircraft, comprising:
a fuselage (1);
trapezoidal wing (2);
two fore counter rotating rotors (3, 4), that are installed (together with engines) in longitudinal position before the wing on the two ends of the fore rotating beam (5), which axis of rotation in vertical-longitudinal plane is perpendicular to the fuselage longitudinal axis;
an aft rotor (6), that is installed (together with engine) in the centre of the aft rotating beam (7), which axis of rotation in vertical-longitudinal plane is perpendicular to the fuselage longitudinal axis;
a cylindrical hinge of the fore rotating beam (5), that is installed on the upper part of the fuselage section,
two cylindrical hinges of the aft rotating beam (7), that are installed in the two symmetric arms (8, 9) of the fixed structure of the tail unit (10), that is attached rigidly to the aft part of the fuselage;
two rotating horizontal stabilizers (11, 12) and two rotating vertical stabilizers (13,14), that have hinges of rotation that are installed in the in the two symmetric arms (8, 9) of the fixed structure of the tail unit (10);
wherein two rotating beams (5,7), two rotating horizontal stabilizers (11, 12) and two rotating vertical stabilizers (13,14) are equipped with rotation servo mechanisms, providing that servo mechanism of the beam (5) is installed in the fuselage and servo mechanisms of the aft rotating beam are installed in the two symmetric arms (8, 9) of the fixed structure of the tail unit (10); the rotors (3, 4, 6) are equipped with servo mechanisms for the propeller pitch control, providing that these servo mechanisms are installed on the front part of the each engine frame; each rotor (3, 4, 6) together with his engine is installed on the corresponding rotating beam through the corresponding hinge (15, 16, 17), which axis is perpendicular to the axis of the rotation of the corresponding rotating beam and each hinge (15, 16, 17) is equipped with rotation servo mechanism.

2. A convertible aircraft according to claim 1, wherein rotors and engines are the turboprop type.

3. A convertible aircraft according to claim 1, wherein electric motors are installed instead of the engines and power supply of these electric motors is provided, preferably, by the electric batteries.

4. A convertible aircraft according to claim 3, wherein in the aft part of the fuselage is installed engine (18), that is or internal combustion piston type engine or turbo-shaft engine, including the cooling devices, gas exhaust devices, thermal and acoustic isolation; and electric power generator (19) that is installed on the shaft of the engine (18) and is connected electrically with electric power management unit (20), which is connected electrically with electric batteries, propulsive electric motors, servo mechanisms and on board radio and electronic devices.

5. A convertible aircraft according to claim 2, wherein the fuselage (101) contains the passenger's cabin (120), floatage component (116) of the fuselage structure, which displacement tonnage is equal to airplane vertical take off weight.

6. A convertible aircraft according to any of claims 1 to 5, which is comprising the control system that have following nine control channels:
i. symmetric rotation of the two vertical stabilizers (13, 14),
ii. symmetric rotation of the two horizontal stabilizers (11, 12),
iii. anti-symmetric rotation of the two horizontal stabilizers (11, 12),
iv. three control channels of the individual thrust of each rotor(3, 4, 6),
v. symmetric rotation of the fore beam (parts 5s, 5d) and aft beam (7) at the one angle ω,
vi. symmetric rotations of the fore rotors (3, 4) and aft rotor (6) inside their hinges (15, 16, 17) at one angle γ in the two parallel planes that are perpendicular to the vertical-longitudinal plane and are containing the axis of rotation of the fore beam (5) or axis of rotation the aft beam (7) and axis of the hinge (15 or 16 or 17) of the corresponding rotor,
vii. rotation of the two fore rotors (3, 4) inside their hinges (15, 16) at the angle γ in the plane that is perpendicular to the vertical-longitudinal plane and is containing the axis of rotation of the fore beam (5) and axes of the hinges (15, 16) and rotation of the aft rotor (6) inside the hinge (17) at the angle: −γ, that is equal to the angle two fore rotors rotation and has opposite sign, providing this rotation in plane that is perpendicular to the vertical-longitudinal plane and is containing the axis of rotation of the aft beam (7) and axis of the hinge (17).
